(19) United States
(12) Patent Application Publication
(10) Pub. No.: US 2007/0208380 A1
(43) Pub. Date: Sep. 6, 2007

(54) Pacifier tooth and gum cleaning device

(76) Inventor: Barbara S. Ebner, Pittsburgh, PA (US)

Correspondence Address: Barbara S. Ebner, 18 Park Place, Pittsburgh, PA, 15205, US

(21) Appl. No.: 10/855,004

(22) Filed: Oct. 9, 2003

(51) Int. Cl. A61J 17/00

(52) U.S. Cl. 606/235

(57) ABSTRACT

The invention relates to the field of infant or toddlers cleaning device in the form of a pacifier. In particular, the modified nipple of the pacifier contains a bristle surface intended to allow an infant or toddler to easily, independently cleanse all of the surfaces of the upper and lower teeth, while simultaneously massaging the gum line. The invention provides a pacifier format having a nipple attached that contains soft flexible bristles. This unique shape allows the infant or toddler to easily massage gums or brush teeth using the sucking action with which the infants and toddlers are familiar. Although the invention is designed for infants and toddlers in mind, it may also be suitable for use by handicapped individuals who do not have the dexterity to use a traditional toothbrush but may wish to independently cleanse their teeth without relying on the interactions of others.

### CROSS REFERENCE TO RELATED APPLICATIONS

References Cited
U.S. Patent Documents

| | | | |
|---|---|---|---|
| 1157413 | October, 1915 | Nesper | 15/227. |
| 3124824 | March, 1964 | Lutz | 15/227. |
| 3368668 | February, 1968 | Micciche | 15/167. |
| 4105120 | August, 1978 | Bradberry | 132/323. |
| 4292705 | October, 1981 | Stouffer | 15/227. |
| 4617694 | October, 1986 | Bori | 15/227. |
| 5213428 | September, 1993 | Salman | 15/167. |
| 5228433 | July, 1993 | Rosen | 15/227. |
| 5348153 | September, 1994 | Cole | 15/227. |

### STATEMENT OF FEDERALLY SPONSORED RESEARCH/DEVELOPMENT

This patent request is not federally sponsored.

### BACKGROUND OF THE INVENTION

The invention relates to the field of infant or toddlers cleaning device in the form of a pacifier, and more particularly to a modification to the pacifier for oral, teeth, or gum cleansing. In particular, the application depicts a tooth or gum cleaning device that has an enlarged bristle surface with a unique shape that is intended to allow an infant or toddler to easily, independently cleanse all of the surfaces of the upper and lower teeth, while simultaneously massaging the gum line.

The invention relates generally to the infant or toddler pacifier, which is specifically designed to clean the teeth and gums while the infant or toddler suckles. For many years, dentists and oral hygienists have recommended that teeth should be brushed after every meal. This is no less true for infants or toddlers. For infants, this is, of course, impossible unless the guardian carries with him a bulky toothbrush and toothpaste and the said guardian diligently brushes the infant or toddlers teeth. In today's world, parents and guardians are strapped for time and often neglect this duty. In view of this fact it is the primary objective of the invention to provide an easy-to-use tooth cleaning mechanism thereby lending them to being used more frequently resulting in improved dental care.

Effectively cleansing the teeth of a toddler or infant under 24 months can be a difficult undertaking. There are many toothbrushes on the market to address the unique teeth/gum cleaning challenges for this group. Most devices simply provide a smaller version of the cleaning devices used by adults and adolescents. However, these devices assume that the person using the devices has the physical dexterity, knowledge, and understanding on how to use the device. These characteristics are not true of the toddler or infant. Therefore, the current most common method of cleansing the teeth or gurns of this age group is to have a parent, guardian, or other person perform the task for the child. This is challenging even with the most cooperative child.

As a result, toddlers and infants teeth and gums are not brushed as often as they should be. Over time, such inadequate brushing can lead not only to bacteria growth, but also to tartar and plaque build up, which may cause a number of adverse health conditions.

The invention of the present application addresses these and other problems present in prior art toothbrushes by providing a unique brush head and bristle structure for this age group. The invention provides a pacifier format having a modified nipple attachment that contains soft flexible bristles. This unique shape allows the infant or toddler to easily massage gums or brush teeth using the sucking action that they are already used to.

Although the invention is designed for infants and toddlers in mind, it may also be suitable for use by handicapped individuals who do not have the dexterity to use a traditional toothbrush but may wish to independently cleanse their teeth without relying on the interactions of others.

### BRIEF SUMMARY OF THE INVENTION

Pacifier nipple and gum cleaning device used to introduce tooth cleaning or polishing compound orally to an infant or toddler. The construction of the pacifier tooth and cleaning device is similar to an ordinary pacifier, a resilient, hollow nipple that extends from an inner facing shield plate, which abuts the external surface of the lips of the infant when the infant has the nipple positioned in the infant's mouth. Short bristles are bonded or molded onto the nipple and project outward from the nipple. The soft bristles massage the small child's gum and/or teeth providing rubbing and stroking action to the interior of the mouth. When used with a cleaning or polishing compound, the infant or toddler can independently cleanse his/her mouth.

### BRIEF DESCRIPTION OF SEVERAL VIEWS OF THE DRAWINGS

For a better understanding of the invention, and to show more visibly how it may be carried into effect, three drawings show the preferred embodiments of the invention, which;

FIG. 1 is a side view of the pacifier tooth and gum-cleaning device used for cleaning gums and teeth of an infant or toddler

FIG. 2 is a partial view of the pacifier tooth and gum-cleaning device focusing on the areas of interest for this invention

FIG. 3 is a sectional view of FIG. 2 of the nipple area, which is of fundamental interest in the pacifier tooth and gum-cleaning device

FIG. 4 is an enhanced color representation of the invention in digital view (JPEG: Joint Photographic Experts Group format) to provide an additional view of the appearance and texture of the final product

### DETAILED DESCRIPTION OF THE INVENTION

### Field of Invention

This invention relates to oral hygiene devices, and in particular, tooth and gum cleaning and massaging devices primarily for use on the teeth and gums of infants and toddlers.

### Description of Prior Art

It has been common practice to administer toothpaste to an infant or toddler with an infant toothbrush, washcloth, or fingers. This procedure is typically done while restraining the child. This is a tedious process and the administration of the toothpaste may be unsatisfactorily inefficient because the infant or toddler is resisting the invasion of the delivery device. Moreover, this teeth and gum cleaning process must be delivered by a third party and is dependent upon their willingness to participate in the process and their ability to be present to administer the procedure.

Various pacifiers and infant oral cleaning devices have been known before and typical prior art devices are shown in U.S. Pat. Nos. 6,514,275 (Pacifier); 6,334,231 (Infant Toothbrush); and 6,447,536 (Teething Pacifier).

The U.S. Pat. No. 6,514,275 describes the pacifier design of a lemniscates-shape shield attached to a nipple. Here, the patentee does not describe the nipple but the shield that is attached to the nipple. This patent is not concerned with the design of the shield, guard, or handles but with the construction and use of the nipple.

Another recent patent, U.S. Pat. No. 6,334,231 describes a brush head attached to a baby bottle. The patentee is suggesting a mechanism that is safe and may be used by infants and children without constant supervision or assistance from a third party.

A further patent of interest is U.S. Pat. No. 6,447,536 where the patentee describes a teething pacifier made up of two different molded teething materials. Here the first teething material is harder than the second teething material.

Despite the presence of these inventions, there is still a need for a mechanism for the infant and toddler population to independently initiate and manipulate the teeth and gum cleaning delivery system.

### Description of Invention

The invention relates to the field of infant or toddlers cleaning device in the form of a pacifier. In particular, the modified nipple of the pacifier contains a bristle surface that is intended to allow an infant or toddler to easily, independently cleanse all of the surfaces of the upper and lower teeth, while simultaneously massaging the gum line.

The invention provides a pacifier format having a nipple attached that contains soft flexible bristles. This unique shape allows the infant or toddler to easily massage gums or brush teeth using the sucking action that they are already used to.

Although the invention is designed for infants and toddlers in mind, it may also be suitable for use by handicapped individuals who do not have the dexterity to use a traditional toothbrush but may wish to independently cleanse their teeth without relying on the interactions of others.

The invention may embody a number of different forms. However, the specification and drawings that follow describe and disclose only some of the specific forms of the invention and are not intended to limit the scope of the invention as defined in the claims herein.

As the user suckles the pacifier device, the soft bristles gently massage the gums and teeth. The objective is to allow the infant or toddler to initiate the brushing action on his or her own through the normal course of suckling a pacifier.

It is therefore the object of this invention to provide a tooth or gum cleaning device to be used by infants or toddlers which is available for them to massage their mouth thoroughly, quicker, and more effectively.

Another objective of the invention is to provide a device that stimulates the gums for better health

Another objective of this invention provides a device that includes a brush head that permits the user to simultaneously brush the upper and lower surfaces of the teeth while simultaneously massaging the gum line.

Another objective of this invention is to provide a portable tooth cleaning mechanism of such small bulk that it may be readily available and used.

It is another objective of the invention to provide a pacifier comprised of a bristle nipple attached to a shield or guard comprised of plastic material. The construction of the nipple is adapted for use in connection with a liquid, paste, or powder, to thoroughly clean and polish teeth.

It is another objective of the invention to provide a self-contained infant or toddler tooth and gum-cleaning device.

It is another objective of the invention to provide a tooth and gum cleaning mechanism that effectively removes food particles and other detritus while stimulating gums for better health.

It is another objective of the invention to provide a tooth and gum cleaning mechanism that permits the infant or toddler to simultaneously brush the upper and lower surfaces of the mouth.

A further objective is to provide a device of the character state which is adapted for use in the mouth either as a tooth cleaner, or as a means for bathing the gums or cleaning the roof or other parts of the mouth and which is sanitary and may be rendered antiseptic.

The device comprises a pacifier arrangement comprised of a shield or guard used as a base and a nipple fastened to the central opening of said shield. The nipple has a soft, resilient nipple that is readily accepted by the infant or toddler, but the nipple has supple bristles extending outwardly from the nipple. The element for the bristles must be resilient enough to not feel uncomfortable for the user (i.e. too stiff) and yet not so pliant as to be merely collapsed during sucking. The bristles will be made from a flexible plastic material suitable for use in dental hygiene. Preferably, the bristles extending from the nipple will range in length from 0.5 to 1 mm.

The tooth and gum-cleaning device takes the form of a nipple; which is of such a shape as to be easily suckled by an infant or toddler. Soft bristles flank a nipple. An oral nipple being formed of a supple plastic material, comprising soft bristles, defining on both the anterior and posterior sides of the nipple. The nipple can be coated with a tooth cleaning and polishing compound or dentifrice. Any suitable dentifrice or tooth-cleaning compound may be employed, which is non-reactive with the plastic used. Preferably included also are bactericidal astringent and flavoring and coloring agents as desired. The porous synthetic nipple not only carries adequate supply of tooth cleaning or polishing compound but it is also very effective as an applicator to the teeth and as a means of cleaning crevices between the teeth and a means to massage the gums.

The embodiments of particular pacifier tooth and gum cleaning device according to the invention will now be described in more detail with reference to the following figures.

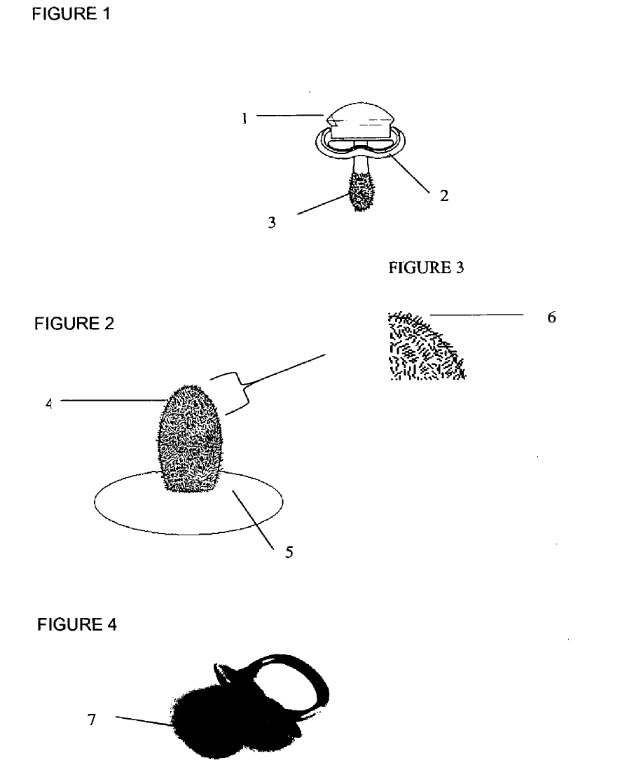

FIG. 1 is a side perspective drawing of the invention and is comprised of a nipple (3) that extends from a broad, inner face of a shield plate attached to a base (1) and typically has a handle extending from the base (2) as is well known in the art of infant pacifiers. The nipple can take the shape of an elongate nipple that has commonly been used in commercial pacifiers that are readily available in the market. The shield plate attached to the base has a concave surface from which the nipple extends that allows the shield plate to fit smoothly about the mouth of the infant or toddler. Soft bristles extend outwardly from the nipple (3) that will gently massage and clean the infant's teeth and gums.

FIG. 2 is a partial view of the pacifier tooth and gum-cleaning device focusing on the areas of interest for this invention. Covering the nipple are soft bristles (4). The soft bristles appear on the entire surface of the nipple and are dispersed closely to each other. FIG. 2 illustrates the abundant amount of short bristles projecting outward from the nipple. The bristles are spaced-apart in relation to one another. The multiplicity of upright bristles attached to the entire surface of the pacifier nipple extending outward defines a large cleaning surface area.

FIG. 3 is an enlarged sectional view of the nipple in FIG. 2 and illustrates the closeness and abundant amount of short bristles (5) that are bonded or molded onto the nipple and project outward from the nipple. The bristles are spaced consistently apart in relation to one another.

FIG. 4 is a color digital image of the invention to aid in the perception of the innovation. The contour of the lines in the image represents the bristles and exemplifies the thinness, elasticity, and length of the bristles on the proposed invention (6). The depiction reveals that the invention is similar to an ordinary pacifier, which will aid in the infant or toddler's acceptance of the tooth and gum-cleaning device. The benefit of this innovation is in the small, condensed-spaced bristles arranged on the nipple that project outward from the nipple. FIG. 4 bears witness to the acceptability and ease-of-use for this device in massaging and cleaning a small child's gums and/or teeth.

1. An improved pacifier arrangement for cleaning teeth and gums:
(i) comprised of a shield or guard used as a base shaped shield having a first side and a second side opposite of the first side and a central shield opening and a nipple fastened to the central opening of said shield; a nipple is fastened in a central opening of the shield; and
(ii) an oral nipple being formed of a supple plastic material; and
(iii) the nipple extending outwardly from said first side of said pacifier shield or guard: a handle associated with said second side of said pacifier shield, guard or end-cap; and
(iv) the form of a nipple which is of such a shape as to be easily suckled by an infant or toddler; and
(v) a nipple sheathed by soft bristles. An abundant amount of short bristles project outward from the nipple. The bristles are spaced consistently apart in relation to one another. The multiplicity of upright bristles attached to the entire surface of the pacifier nipple extending outward defining a large cleaning surface area sufficient to simultaneously engage the upper and lower teeth or gum area during brushing; and

2. The device of claim 1 wherein said tooth and gum-cleaning device:
(i) the nipple is flanked by soft bristles. Soft elastic bristles, on all sides of the orbicular-shaped nipple; and
(ii) ample amount of short bristles are bonded or molded onto the nipple and project outward from the nipple; and
(ii) the bristles are spaced uniformly apart in relation to one another. The multiplicity of upright bristles attached to the entire surface of the pacifier nipple extending outward defining a large cleaning surface area sufficient to simultaneously engage the upper and lower teeth or gum area during brushing; and

3. The device as claimed in claim 2 wherein the nipple contains substantially uniform bristle density; and

4. The device as claimed in claim 2 wherein the plurality of bristles positioned on said nipple are spaced about the circumference of the said nipple forming a generally spherical brush; and

5. The device of claim 2 may be filled, impregnated, or coated with a tooth cleaning and polishing compound or dentifrice. Any suitable dentifrice or tooth-cleaning compound may be employed, which is non-reactive with the plastic used. Preferably included also are bactericidal astringent and flavoring and coloring agents as desired; and

6. The device of claim 1 is an oral cleaning device comprised of a handle, which the infant or toddler manually operates.
